(19) United States
(12) Patent Application Publication
(10) Pub. No.: US 2022/0164545 A1
(43) Pub. Date: May 26, 2022

(54) DIALOG ACTION ESTIMATION DEVICE, DIALOG ACTION ESTIMATION METHOD, DIALOG ACTION ESTIMATION MODEL LEARNING DEVICE, AND PROGRAM

(71) Applicant: NIPPON TELEGRAPH AND TELEPHONE CORPORATION, Tokyo (JP)

(72) Inventors: Nozomi KOBAYASHI, Tokyo (JP); Kuniko SAITO, Tokyo (JP); Junji TOMITA, Tokyo (JP)

(73) Assignee: NIPPON TELEGRAPH AND TELEPHONE CORPORATION, Tokyo (JP)

(21) Appl. No.: 17/602,281

(22) PCT Filed: Mar. 25, 2020
(86) PCT No.: PCT/JP2020/013445

§ 371 Date: Oct. 7, 2021

(30) Foreign Application Priority Data
Apr. 10, 2019 (JP) 2019-075055

(51) Int. Cl. G06F 40/35; G06F 40/279

(52) U.S. Cl. CPC G06F 40/35; G06F 40/279

(57) ABSTRACT

To enable accurate estimation of a dialogue act type taking utterance subject into account.

A feature value extraction unit 130 extracts feature values including an utterance subject feature value which is a feature value related to an utterance subject of an utterance sentence for each of a first utterance sentence and a second utterance sentence, the second utterance sentence being an utterance sentence preceding the first utterance sentence, including at least the utterance sentence immediately preceding the first utterance sentence. A dialogue act estimation unit 260 estimates a dialogue act type of the first utterance sentence using the aggregate feature value generated by aggregating the extracted feature values for each of the first utterance sentence and the second utterance sentence and a previously learned dialogue act estimation model for estimating the dialogue act type indicating a kind of dialogue act taking into account the utterance subject of an utterance sentence.

### TECHNICAL FIELD

The present invention relates to a dialogue act estimation device, a dialogue act estimation method, a dialogue act estimation model learning device, and a program.

### BACKGROUND ART

There have been studies on dialogue act estimation, which is one of important techniques for a dialogue system to understand the intent of a user and generate a response. Dialogue act estimation refers to estimating a type of a dialogue act that indicates the intent of a relevant utterance sentence in a dialogue. As an example, for an utterance sentence “Gomen-nasai (I'm sorry)”, correctly estimating the type of the dialogue act “apology” enables control such that a response of the dialogue act “acceptance of apology” should be made for the user's utterance sentence “Gomen-nasai (I'm sorry)”. While a set of dialogue act types (a dialogue act scheme) used by researchers is often developed on their own in their respective studies, a dialogue act scheme called ISO24617-2 has been recently proposed.

Also, conventional dialogue act estimation techniques employ models for estimating previously learned dialogue acts on the basis of supervised learning (dialogue act estimation models), and feature values used therein are morphemes contained in a user's utterance sentence which result from morpheme analysis of the utterance sentence, the dialogue act immediately preceding the utterance sentence, the number of characters, word n-grams and the like (Non-Patent Literature 1, for instance). Approaches used in learning so far reported include support vector machine (SVM), conditional random field (CRF), logistic regression and the like, for example.

### CITATION LIST

### Non-Patent Literature

Non-Patent Literature 1: Fukuoka Tomotaka, Shirai Kiyoaki, “Dialog Act Classification Using Features Intrinsic to Dialog Acts in an Open-Domain Conversation”, Natural Language Processing, Vol. 24, No. 4, 2017.

### SUMMARY OF THE INVENTION

### Technical Problem

A common method for generating a response utterance sentence in a dialogue system is applying a response utterance sentence generation logic for each dialogue act type estimated. From this perspective, it is desirable to be able to estimate a dialogue act scheme at a granularity corresponding to the utterance sentence generation logic that should respond.

However, the conventional dialogue act estimation has a challenge of non-correspondence of the granularity. For example, in ISO24617-2, a dialogue act type called “Question” exists; however, this dialogue act type includes both an utterance sentence concerning the system (a second party) like “Anatano namae wa? (What's your name?)” and an utterance sentence concerning a third party like “Shusho no namae wa? (What's the name of the prime minister?)”. These two need to be distinguished because different generation logics are assumed: for the former, an answer is generated by searching a prepared personal database of the system, while for the latter, an answer is generated by searching for information present on a general internet. However, the conventional dialogue act estimation has an issue of not taking into account “about what/about whom (hereinafter, utterance subject)”.

The present invention has been made in view of the foregoing and is aimed at providing a dialogue act estimation device, a dialogue act estimation method, and a program that can accurately estimate a dialogue act type taking the utterance subject into account. The present invention is also aimed at providing a dialogue act estimation model learning device for accurately estimating a dialogue act type taking the utterance subject into account.

### Means for Solving the Problem

A dialogue act estimation device according to the present invention includes: an input unit configured to receive input of a first utterance sentence and a second utterance sentence, the second utterance sentence being an utterance sentence preceding the first utterance sentence, including at least the utterance sentence immediately preceding the first utterance sentence; a feature value extraction unit configured to extract feature values including an utterance subject feature value which is a feature value related to an utterance subject of an utterance sentence for each of the first utterance sentence and the second utterance sentence, and to aggregate the extracted feature values for each of the first utterance sentence and the second utterance sentence into an aggregate feature value; and a dialogue act estimation unit configured to estimate a dialogue act type of the first utterance sentence using the aggregate feature value and a previously learned dialogue act estimation model for estimating the dialogue act type indicating a kind of dialogue act taking into account the utterance subject of an utterance sentence.

In a dialogue act estimation method according to the present invention, an input unit receives input of a first utterance sentence and a second utterance sentence, the second utterance sentence being an utterance sentence preceding the first utterance sentence, including at least the utterance sentence immediately preceding the first utterance sentence; a feature value extraction unit extracts feature values including an utterance subject feature value which is a feature value related to an utterance subject of an utterance sentence for each of the first utterance sentence and the second utterance sentence, and aggregates the extracted feature values for each of the first utterance sentence and the second utterance sentence into an aggregate feature value; and a dialogue act estimation unit estimates a dialogue act type of the first utterance sentence using the aggregate feature value and a previously learned dialogue act estimation model for estimating the dialogue act type indicating a kind of dialogue act taking into account the utterance subject of an utterance sentence.

A program according to the present invention is a program for causing a computer to execute processing including: receiving, by an input unit, input of a first utterance sentence and a second utterance sentence, the second utterance sentence being an utterance sentence preceding the first utterance sentence, including at least the utterance sentence immediately preceding the first utterance sentence; extracting, by a feature value extraction unit, feature values including an utterance subject feature value which is a feature value related to an utterance subject of an utterance sentence for each of the first utterance sentence and the second utterance sentence, and aggregating the extracted feature values for each of the first utterance sentence and the second utterance sentence into an aggregate feature value; and estimating, by a dialogue act estimation unit, a dialogue act type of the first utterance sentence using the aggregate feature value and a previously learned dialogue act estimation model for estimating the dialogue act type indicating a kind of dialogue act taking into account the utterance subject of an utterance sentence.

According to the dialogue act estimation device, the dialogue act estimation method, and the program according to the present invention, the input unit receives input of a first utterance sentence and a second utterance sentence, which is the utterance sentence immediately preceding the first utterance sentence, the feature value extraction unit extracts an utterance subject feature value which is a feature value related to an utterance subject of an utterance sentence for each of the first utterance sentence and the second utterance sentence, and aggregates the extracted feature values for each of the first utterance sentence and the second utterance sentence into an aggregate feature value.

Then, the dialogue act estimation unit estimates the dialogue act type of the first utterance sentence using the aggregate feature value and a previously learned dialogue act estimation model for estimating the dialogue act type indicating the kind of dialogue act taking into account the utterance subject of an utterance sentence.

In this manner, a dialogue act type taking the utterance subject into account can be accurately estimated by extracting feature values including utterance subject feature values, which are feature values related to the utterance subjects of utterance sentences, for each of the first utterance sentence and the second utterance sentence, which is an utterance sentence preceding the first utterance sentence, including at least the utterance sentence immediately preceding the first utterance sentence, and by estimating the dialogue act type of the first utterance sentence using aggregate feature value generated by aggregating the extracted feature values for each of the first utterance sentence and the second utterance sentence, and a previously learned dialogue act estimation model for estimating the dialogue act type indicating the kind of dialogue act taking into account the utterance subject of an utterance sentence.

The feature value extraction unit of the dialogue act estimation device according to the present invention may include: an utterance key segment identification section configured to identify an utterance key segment for each of the first utterance sentence and the second utterance sentence, the utterance key segment being a segment that best represents a content of an utterance sentence; a functional feature value extraction section configured to extract a functional feature value, the functional feature value being a functional feature value of the utterance sentence contained in the utterance key segment for each of the first utterance sentence and the second utterance sentence identified by the utterance key segment identification section; an utterance subject feature value extraction section configured to extract the utterance subject feature value of each of the first utterance sentence and the second utterance sentence based on the utterance key segment for each of the first utterance sentence and the second utterance sentence identified by the utterance key segment identification section; and a feature value aggregation section configured to generate the aggregate feature value by aggregating the functional feature value for each of the first utterance sentence and the second utterance sentence extracted by the functional feature value extraction section, and the utterance subject feature value for each of the first utterance sentence and the second utterance sentence extracted by the utterance subject feature value extraction section.

A dialogue act estimation model learning device according to the present invention includes: an input unit configured to receive input of learning data including a first utterance sentence, a second utterance sentence, the second utterance sentence being an utterance sentence preceding the first utterance sentence, including at least the utterance sentence immediately preceding the first utterance sentence, and a dialogue act type indicating a kind of dialogue act taking into account an utterance subject of the first utterance sentence; a feature value extraction unit configured to extract feature values including an utterance subject feature value which is a feature value related to an utterance subject of an utterance sentence for each of the first utterance sentence and the second utterance sentence, and to aggregate the extracted feature values for each of the first utterance sentence and the second utterance sentence into an aggregate feature value; and a model learning unit configured to learn parameters of a dialogue act estimation model for estimating the dialogue act type indicating the kind of dialogue act taking into account the utterance subject of an utterance sentence, the learning performed such that the dialogue act type of the first utterance sentence which is estimated based on the aggregate feature value for the first utterance sentence and the second utterance sentence extracted by the feature value extraction unit and on the dialogue act estimation model agrees with the dialogue act type of the first utterance sentence included in the learning data.

In this manner, the dialogue act estimation model learning device according to the present invention can learn a dialogue act estimation model for accurately estimating a dialogue act type taking the utterance subject into account, by extracting feature values including utterance subject feature values, which are feature values related to the utterance subjects of utterance sentences, for each of the first utterance sentence and the second utterance sentence, which is an utterance sentence preceding the first utterance sentence, including at least the utterance sentence immediately preceding the first utterance sentence, and by learning the parameters of the dialogue act estimation model such that the dialogue act type of the first utterance sentence which is estimated based on the aggregate feature value generated by aggregating the extracted feature values for each of the first utterance sentence and the second utterance sentence respectively and on the dialogue act estimation model agrees with the dialogue act type of the first utterance sentence included in the learning data.

### Effects of the Invention

The dialogue act estimation device, the dialogue act estimation method, and the program of the present invention can accurately estimate a dialogue act type taking the utterance subject into account. Further, the dialogue act estimation model learning device of the present invention can learn a dialogue act estimation model for accurately estimating a dialogue act type taking the utterance subject into account.

### BRIEF DESCRIPTION OF DRAWINGS

FIG. 1 is a block diagram showing a general configuration of a computer that functions as a dialogue act estimation model learning device and a dialogue act estimation device according to an embodiment of the present invention.

FIG. 2 is a block diagram showing a configuration of the dialogue act estimation model learning device according to an embodiment of the present invention.

FIG. 3 is a schematic diagram showing a detailed configuration of a feature value extraction unit according to an embodiment of the present invention.

FIG. 4 is a flowchart illustrating a dialogue act estimation model learning process routine of the dialogue act estimation model learning device according to an embodiment of the present invention.

FIG. 5 is a block diagram showing a configuration of the dialogue act estimation device according to an embodiment of the present invention.

FIG. 6 is a flowchart illustrating a dialogue act estimation process routine of the dialogue act estimation device according to an embodiment of the present invention.

### DESCRIPTION OF EMBODIMENTS

<Configuration of Dialogue Act Estimation Model Learning Device According to an Embodiment of the Present Invention>

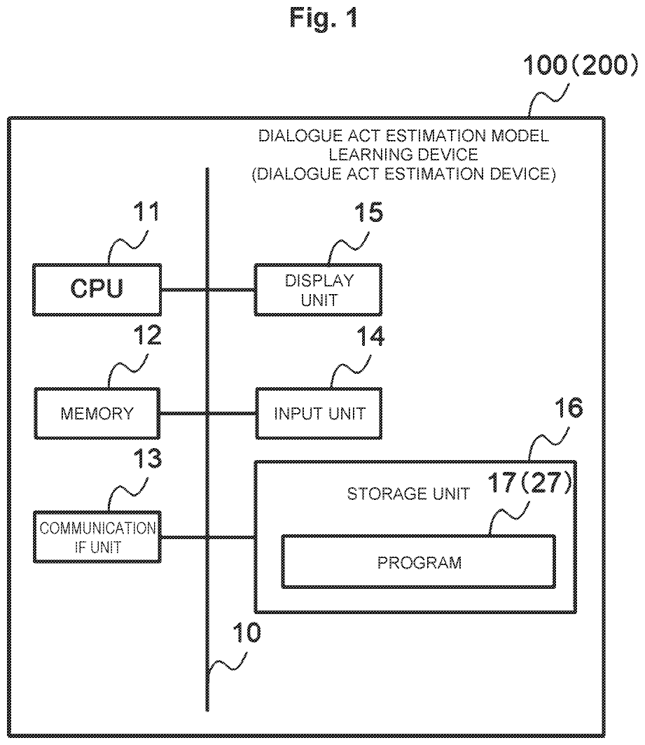

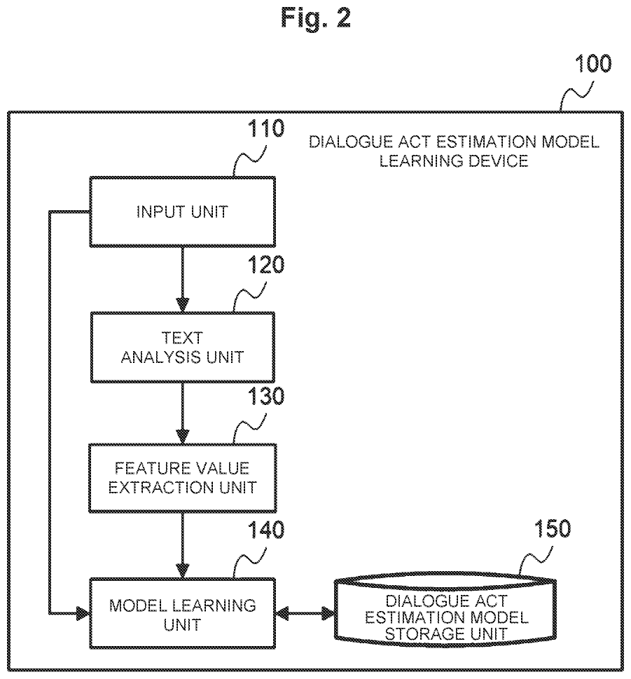

Referring to FIGS. 1 and 2, configuration of a dialogue act estimation model learning device 100 according to an embodiment of the present invention is described. FIG. 1 is a block diagram showing a general configuration of a computer that functions as the dialogue act estimation model learning device 100 according to an embodiment of the present invention. FIG. 2 is a block diagram showing a configuration of the dialogue act estimation model learning device 100 according to an embodiment of the present invention.

As shown in FIG. 1, the dialogue act estimation model learning device 100 according to an embodiment of the present invention is composed of a computer including a CPU 11, a memory 12 such as RAM, a communication interface (IF) unit 13, an input unit 14 such as a keyboard, a display unit 15 such as a display, and a storage unit 16 such as ROM storing a program 17 for executing a dialogue act estimation model learning process routine discussed later. The CPU 11, the memory 12, the communication IF unit 13, the input unit 14, the display unit 15, and the storage unit 16 are connected via a bus 10. The communication IF unit 13 can be connected to an external terminal over a communication line such as a LAN cable.

As shown in FIG. 2, the dialogue act estimation model learning device 100 according to an embodiment of the present invention includes an input unit 110, a text analysis unit 120, a feature value extraction unit 130, a model learning unit 140, and a dialogue act estimation model storage unit 150.

The input unit 110 receives input of learning data including a first utterance sentence, a second utterance sentence, which is an utterance sentence preceding the first utterance sentence, including at least the utterance sentence immediately preceding the first utterance sentence, and a dialogue act type indicating a kind of dialogue act taking into account the utterance subject of the first utterance sentence. Specifically, the learning data includes history of utterance sentences and the dialogue act type of each utterance sentence, and the input unit 110 receives input of multiple learning data. History of utterance sentences includes at least a pair formed of the first utterance sentence, which is the final utterance sentence, and the second utterance sentence, which is the immediately preceding utterance sentence, and are utterance sentences from the start of a dialogue act to the present time. However, if the first utterance sentence is the initial utterance at the start of utterance, the second utterance sentence, i.e., the immediately preceding utterance sentence, will be empty. If the pair is included, as a set of utterance sentences, a predetermined period or a predetermined number of utterance sentences, for example, N utterance sentences from the most recent utterance sentences, may be used as the history of utterance sentences. Also, the first utterance sentence and the second utterance sentence are utterance sentences in the dialogue system, the second utterance sentence being an utterance sentence resulting from an utterance of the system and the first utterance sentence being an utterance sentence resulting from an utterance of the user.

In order to enable dialogue act estimation taking the utterance subject into account, the first utterance sentence and the second utterance sentence need to be in a scheme in which the scheme of the dialogue act itself takes the utterance subject into account. A scheme that takes the utterance subject into account is a scheme in which the conventional dialogue acts are subdivided according to utterance subjects. For example, a scheme that takes the utterance subject into account is a scheme in which the dialogue act Question is subdivided such that Question: I is a question to a first party, Question: II is a question to a second party, and Question: III is a question to a third party. That is to say, it is defined that the utterance subject of an utterance sentence is classified into the first party I as the speaker (user), the second party II as the other party of communication (the system), or a third party III as a person or object other than the two. Here, Questions: I to III are dialogue act types that indicate the kind of dialogue act taking the utterance subject of the utterance sentence into account. In the following, the present embodiment is described by illustrating a scheme that takes the utterance subject into account with respect to the dialogue act Question mentioned above.

A specific example of learning data can be:

### Example 1

The second utterance sentence: “Konnichiwa, nanika kikitaikoto wa arimasuka? (Hello, do you have any questions?)”; the first utterance sentence: “Ima keiyakushiteiru sabisu nitsuite kikitainodesuga (I want to ask about the service I currently subscribe to)”; and the dialogue act type of the first utterance sentence: “Question: III”,

### Example 2

The second utterance sentence: “Konnichiwa, nanika kikitaikoto wa arimasuka? (Hello, do you have any questions?)”; the first utterance sentence: “Anatano namae wa naani? (What's your name?)”; and the dialogue act type of the first utterance sentence: “Question: II”.

In (Example 1), since the utterance subject of the first utterance sentence is Question about “sabisu (service)”, or a third party, the dialogue act type “Question: III” indicative of a question to a third party has been given to the learning data as the correct answer. In (Example 2), the utterance subject of the first utterance sentence is Question about “anata (you)”, or the second party, so that the dialogue act type “Question: II” indicative of a question to the second party has been given to the learning data as the correct answer.

Then, the input unit 110 passes the first utterance sentence and the second utterance sentence included in the received learning data to the text analysis unit 120 and passes the dialogue act type of the first utterance sentence included in the learning data to the model learning unit 140.

The text analysis unit 120 determines morpheme information and dependency information of the utterance sentences for each of the first utterance sentence and the second utterance sentence.

Specifically, the text analysis unit 120 determines morpheme information and dependency information by morpheme analysis and dependency analysis, which are known techniques, for each of the first utterance sentence and the second utterance sentence. Morpheme information is information on morphemes such as part-of-speech and end-form, and segment information includes information on “segment ID, target segment ID/dependency type, head morpheme number/function word morpheme number”. An exemplary analysis of the first utterance sentence in (Example 1) above “Ima keiyakushiteiru sabisu nitsuite kikitainodesuga (I want to ask about the service I currently subscribe to)”, is shown in the table below.

TABLE 1

| | | | |
|---|---|---|---|
| Morpheme | Part of | Standard | End |
| notation | speech | notation | form |

segment information: 0 1D 0/0

| | | |
|---|---|---|
| ima | noun: time: continuative | ima |

segment information: 1 2D 0/4

| | | | |
|---|---|---|---|
| keiyaku | noun: action | keiyaku | |
| shi | verb conjugation ending | shi | |
| te | verb suffix: connection: | te | |
| | continuative | | |
| i | verb stem: A:L te-continuative | i | iru |
| ru | verb suffix: adnominal | ru | |

segment information: 2 3D 0/1

| | | |
|---|---|---|
| sabisu | noun, action | sabisu |
| nitsuite | case particle: continuative | nitsuite |

segment information: 3-10 0/6

| | | | |
|---|---|---|---|
| ki | verb stem: K | ki | kiku |
| ki | verb conjugation ending | ki | |
| ta | verb suffix: adjective stem | ta | tai |
| i | adjective suffix: adnominal | i | |
| no | auxiliary noun | no | |
| desu | copula: connection | desu | |
| ga | connection suffix: continuative | ga | |

Then, the text analysis unit 120 passes the morpheme information and dependency information determined for each of the first utterance sentence and the second utterance sentence to the feature value extraction unit 130.

The feature value extraction unit 130 extracts an utterance subject feature value, which is a feature value related to the utterance subject of the utterance sentence, for each of the first utterance sentence and the second utterance sentence, and aggregates the extracted utterance subject feature values for each of the first utterance sentence and the second utterance sentence into an aggregate feature value.

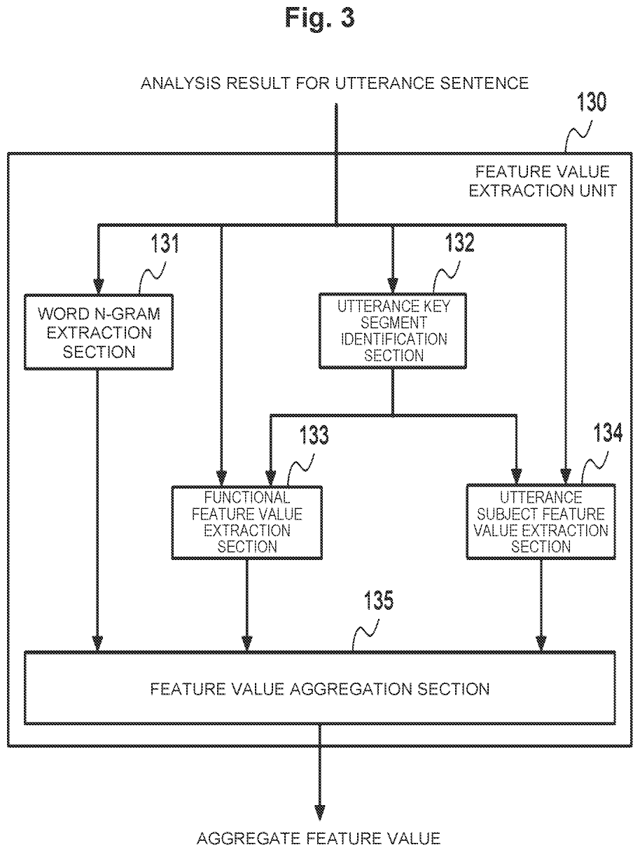

Specifically, as shown in FIG. 3, the feature value extraction unit 130 includes a word n-gram extraction section 131, an utterance key segment identification section 132, a functional feature value extraction section 133, an utterance subject feature value extraction section 134, and a feature value aggregation section 135.

The word n-gram extraction section 131 extracts n-grams for each of the first utterance sentence and the second utterance sentence.

Specifically, the word n-gram extraction section 131 extracts n-grams in morpheme notation from the morpheme information and dependency information for each of the first utterance sentence and the second utterance sentence determined by the text analysis unit 120. For example, 5-grams for the first utterance sentence in (Example 1) above “Ima keiyakushiteiru sabisu nitsuite kikitainodesuga (I want to ask about the service I currently subscribe to)”, will be as shown below. Here, “BOS” and “EOS” are added to the start and the end of the sentence, respectively.

<<5-grams>

### BOS-Ima

### BOS-Ima-keiyaku

### BOS-Ima-keiyaku-shi

### BOS-Ima-keiyaku-shi-te

### Ima-keiyaku-shi-te-i

. . . (omitted) . . .
ta-i-no-desu-ga
i-no-desu-ga-EOS
no-desu-ga-EOS
desu-ga-EOS

Then, the word n-gram extraction section 131 passes the extracted n-grams to the feature value aggregation section 135. The word n-gram extraction section 131 may extract n-grams using the standard notation or the end-form instead of morpheme notation.

The utterance key segment identification section 132 identifies an utterance key segment, which is a segment that best represents the content of the utterance sentence, for each of the first utterance sentence and the second utterance sentence.

Specifically, the utterance key segment identification section 132 identifies the last segment that contains the predicate of the main clause as the utterance key segment for each of the first utterance sentence and the second utterance sentence. If the predicate of the main clause does not exist (e.g., an independent word, etc.), the utterance key segment identification section 132 identifies the segment that contains the last independent word of the utterance sentence and the like as the utterance key segment. As an example, for an utterance sentence “Domo konnichiwa (Hi, hello)”, the utterance key segment identification section 132 identifies “konnichiwa (hello)” as the utterance key segment.

Then, the utterance key segment identification section 132 passes the identified utterance key segments for the respective ones of the first utterance sentence and the second utterance sentence to the functional feature value extraction section 133 and the utterance subject feature value extraction section 134.

The functional feature value extraction section 133 extracts functional feature values, which are functional feature values of the utterance sentence contained in the utterance key segment for each of the first utterance sentence and the second utterance sentence identified by the utterance key segment identification section 132.

Specifically, the functional feature value extraction section 133 extracts function-related feature values such as the part of speech, tense, and modality of words contained in the utterance key segment of each utterance sentence for each of the first utterance sentence and the second utterance sentence. More specifically, the functional feature value extraction section 133 merges feature values that are extracted by application of rules (1) through (3) below to the utterance key segment into a functional feature value.

(1) When the part of speech of the head of the utterance key segment is “adjective stem”, “verb stem”, “noun: action”, or “noun: epithet”, the part of speech in question is combined with “MPOS_” to form a feature value.
(2) When the utterance sentence has only one segment, “ONLY” shall be the feature value.
(3) Function words that appear after the head of the utterance key segment are extracted and if there is information matching (3-A) or (3-B) below, it is extracted as a feature value of tense information (past), modality information (wish, will, imperative, forbiddance, question, etc.).

### (3-A) Extraction of Tense Information

If morpheme notation “ta” [an auxiliary verb] that includes “suffix: end” in the part of speech is present after the predicate, then “PAST_T” is output.

### (3-B) Extraction of Modality Information

“Wish”: If a morpheme having the end-form of “tai (want to)” is present after the predicate, then “MOD_WNT” is output.

“Imperative: If the verb is imperative like “shiro (do it)” or “kae-re (go home)”, then “MOD IMP” is output.

Forbiddance: If the predicate is the original form of a verb and if “na” [particle] is present immediately after it, then “MOD_FBD” is output.

“Question”: If the final morpheme of the segment is “?” or an end particle “ka” representing a question, or an interrogative such as “nani (what)”, “doko (where)” and “dare (who)”, then “MOD_Q” is output.

“Request”: If the predicate is a verb and the immediately subsequent morpheme notation is “te” [particle], then “MOD_REQ” is output if it is followed by any of the notations included in the list below or if there is no subsequent notation.

[List]: “kure (give me)”, “kudasai (please give me)”, “itadaku (get)”, “choudai (give me)”, “morau (get)”, “hoshii (want)”, “moraitai (want to get)”

For example, in the case of the first utterance sentence in (Example 1) above “Ima keiyakushiteiru sabisu nitsuite kikitainodesuga (I want to ask about the service I currently subscribe to)”, the functional feature value extraction section 133 extracts “MPOS_verb stem” from “kiku (hear)”, which is the head of the utterance key segment, and “MOD_WNT” from “tai (want to)” as feature values, and merges these feature values into a functional feature value. The functional feature value extraction section 133 also extracts functional feature values for the second utterance sentence in a similar manner. Then, the functional feature value extraction section 133 passes the extracted functional feature values for each of the first utterance sentence and the second utterance sentence to the feature value aggregation section 135.

The utterance subject feature value extraction section 134 extracts the utterance subject feature value of each of the first utterance sentence and the second utterance sentence based on the utterance key segment for each of the first utterance sentence and the second utterance sentence identified by the utterance key segment identification section 132.

Specifically, the utterance subject feature value extraction section 134 extracts arguments accompanying a case particle or continuative particle, such as “ga”, “wa”, “mo”, “wo”, “nitsuite” and “to-iu”, that is dependent on the utterance key segment (hereinafter collectively referred to as case notation) and generates feature values in the following procedure. Note that an argument herein refers to a content word that is dependent on the utterance key segment with a case particle or a continuative particle.

<<Procedure>>

A sequence equivalent to a noun (the part of speech being a noun or an unknown word) that appears before the case notation is extracted as an argument notation and the process from (A) through (E) below is performed.

(A) If the argument notation represents the second party such as “anata (you)”, “omae (you)”, “temee (you)”, and “anta (you)”, “II_case notation” shall be the utterance subject feature value. Here, the “case notation” is replaced with the appropriate notation.
(B) If the argument notation represents the first party such as “watashi (I)”, “watakushi (I)” or “ore (I)”, “I_case notation” shall be the utterance subject feature value.
(C) When the argument notation is other than the above and if there is an argument that is dependent on the argument of interest with “no” [particle], (A) or (B) above is applied to that argument. If either is unapplicable, “III_case notation” is extracted as the utterance subject feature value. For example, Example 1: “sabisu nitsuite”→“III_nitsuite” and Example 2: “Anatano namae”→“II_no”.
(D) If no argument notation is present and if the utterance is at the beginning of the dialogue (i.e., no immediately preceding utterance), “II_ELM” is extracted as the utterance subject feature value.
(E) If no argument notation is present and if other than (D) above, “SBJ_UNK” shall be the utterance subject feature value.

Then, the utterance subject feature value extraction section 134 passes the extracted utterance subject feature value for each of the first utterance sentence and the second utterance sentence to the feature value aggregation section 135.

The feature value aggregation section 135 generates an aggregate feature value by aggregating the n-grams for each of the first utterance sentence and the second utterance sentence extracted by the word n-gram extraction section 131, the functional feature values for each of the first utterance sentence and the second utterance sentence extracted by the functional feature value extraction section 133, and the utterance subject feature value for each of the first utterance sentence and the second utterance sentence extracted by the utterance subject feature value extraction section 134.

Specifically, the feature value aggregation section 135 aggregates the word n-gram feature values, functional feature values, and utterance subject feature values into one feature value. In doing so, the feature value aggregation section 135 distinguishes between the feature values for the first utterance sentence and the feature values for the second utterance sentence by assigning labels such as “TARGET” and “PRE”. When there are utterance sentences two or more earlier in the history of utterance sentences, they are distinguished by assigning different labels like “PRE2”, “PRE3”. This is because the first utterance sentence and the second utterance sentence, which is an utterance sentence including at least the utterance sentence immediately preceding the first utterance sentence (the last but one), are important in the embodiments of the present invention, and so different labels are assigned in order to make them distinguishable.

For example, in the case of the first utterance sentence in (Example 1) above “Ima keiyakushiteiru sabisu nitsuite kikitainodesuga (I want to ask about the service I currently subscribe to)”, the feature value aggregation section 135 gets “TARGET_BOS-ima TARGET_BOS-ima-keiyaku . . . PRE_BOS-Konnichiwa . . . PRE_TARGET_verb stem . . . TARGET_MPOS_verb stem TARGET_MOD_WNT TARGET_III_nitsuite PRE_MOD_Q PRE_III_wa” as the aggregate feature value. Similarly, in the case of the first utterance sentence in (Example 2) above “Anatano namae wa naani? (What's your name?)”, the feature value aggregation section 135 gets “TARGET_BOS-anata TARGET_BOS-anata-no . . . PRE_masu-ka-?-EOS TARGET_MOD_Q TARGET_II_no PRE_MOD_Q PRE_III_wa” as the aggregate feature value. Then, the feature value aggregation section 135 passes the aggregate feature value to the model learning unit 140.

The model learning unit 140 learns parameters of a dialogue act estimation model such that the dialogue act type of the first utterance sentence which is estimated based on the aggregate feature value for the first utterance sentence and the second utterance sentence included in the learning data extracted by the feature value extraction unit 130 and on the dialogue act estimation model agrees with the dialogue act type of the first utterance sentence included in the learning data.

Specifically, the model learning unit 140 learns the dialogue act estimation model using an existing machine learning model. Although the present embodiment is described taking a case of learning with logistic regression as an example, support vector machine (SVM), conditional random field (CRF) and the like may be used instead. The model learning unit 140 learns the parameters of the dialogue act estimation model so that a dialogue act taking the utterance subject into account will be correctly estimated, that is, so that the dialogue act type which is estimated when the aggregate feature value extracted by the feature value extraction unit 130 is input to the dialogue act estimation model agrees with the dialogue act type of the first utterance sentence that is included in the learning data. The model learning unit 140 repeats a learning process until a predetermined ending condition is satisfied, such as a condition that the learning process is repeated for a predetermined number of learning data. Then, the model learning unit 140 stores the learned parameters of the dialogue act estimation model in the dialogue act estimation model storage unit 150.

The dialogue act estimation model storage unit 150 has stored therein the dialogue act estimation model and the parameters of the dialogue act estimation model learned by the model learning unit 140.

<Action of the Dialogue Act Estimation Model Learning Device According to an Embodiment of the Present Invention>

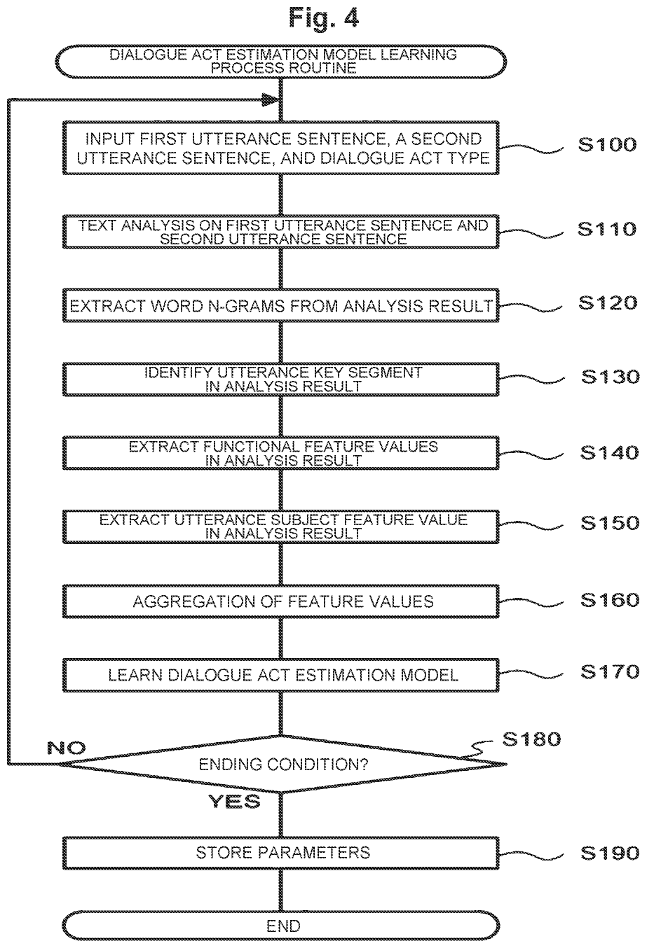

FIG. 4 is a flowchart illustrating a dialogue act estimation model learning routine according to an embodiment of the present invention. When learning data is input to the input unit 110, the dialogue act estimation model learning process routine shown in FIG. 4 is executed at the dialogue act estimation model learning device 100.

First, in step S100, the input unit 110 receives input of learning data including a first utterance sentence, a second utterance sentence, which is the utterance sentence immediately preceding the first utterance sentence, and a dialogue act type indicating a kind of dialogue act taking into account the utterance subject of the first utterance sentence.

In step S110, the text analysis unit 120 determines morpheme information and dependency information of the utterance sentences for each of the first utterance sentence and the second utterance sentence.

In step S120, the word n-gram extraction section 131 extracts n-grams for each of the first utterance sentence and the second utterance sentence which are input from step S110.

In step S130, the utterance key segment identification section 132 identifies an utterance key segment, i.e., a segment that best represents the content of the utterance sentence, for each of the first utterance sentence and the second utterance sentence which are input from step S110.

In step S140, the functional feature value extraction section 133 extracts functional feature values, which are functional feature values of the utterance sentence contained in the utterance key segment for each of the first utterance sentence and the second utterance sentence identified in step S130.

In step S150, the utterance subject feature value extraction section 134 extracts the utterance subject feature value for each of the first utterance sentence and the second utterance sentence based on the utterance key segment for each of the first utterance sentence and the second utterance sentence identified in step S130.

In step S160, the feature value aggregation section 135 generates an aggregate feature value by aggregating the n-grams for each of the first utterance sentence and the second utterance sentence extracted in step S120, the functional feature values for each of the first utterance sentence and the second utterance sentence extracted in step S140, and the utterance subject feature value for each of the first utterance sentence and the second utterance sentence extracted in step S150.

In step S170, the model learning unit 140 learns the parameters of the dialogue act estimation model such that the dialogue act type of the first utterance sentence which is estimated based on the aggregate feature value for the first utterance sentence and the second utterance sentence included in the learning data extracted in step S160 and on the dialogue act estimation model agrees with the dialogue act type of the first utterance sentence included in the learning data which is input from step S110.

In step S180, the model learning unit 140 determines whether the ending condition is met or not.

If the ending condition is not met (NO in step S180), the flow returns to step S100 and the processing from step S100 to S180 is repeated. If the ending condition is met (YES in step S180), then in step S190 the model learning unit 140 stores the learned parameters of the dialogue act estimation model in the dialogue act estimation model storage unit 150.

As described above, the dialogue act estimation model learning device according to an embodiment of the present invention is capable of the following: the dialogue act estimation model learning device can extract feature values including utterance subject feature values, which are feature values related to the utterance subjects of utterance sentences, for each of a first utterance sentence and a second utterance sentence, which is an utterance sentence preceding the first utterance sentence, including at least the utterance sentence immediately preceding the first utterance sentence. Furthermore, the dialogue act estimation model learning device can learn a dialogue act estimation model for accurately estimating a dialogue act type taking the utterance subject into account by learning the parameters of the dialogue act estimation model such that the dialogue act type of the first utterance sentence which is estimated based on the aggregate feature value generated by aggregating the extracted feature values for each of the first utterance sentence and the second utterance sentence and on the dialogue act estimation model agrees with the dialogue act type of the first utterance sentence included in the learning data.

<Configuration of Dialogue Act Estimation Device According to an Embodiment of the Present Invention>

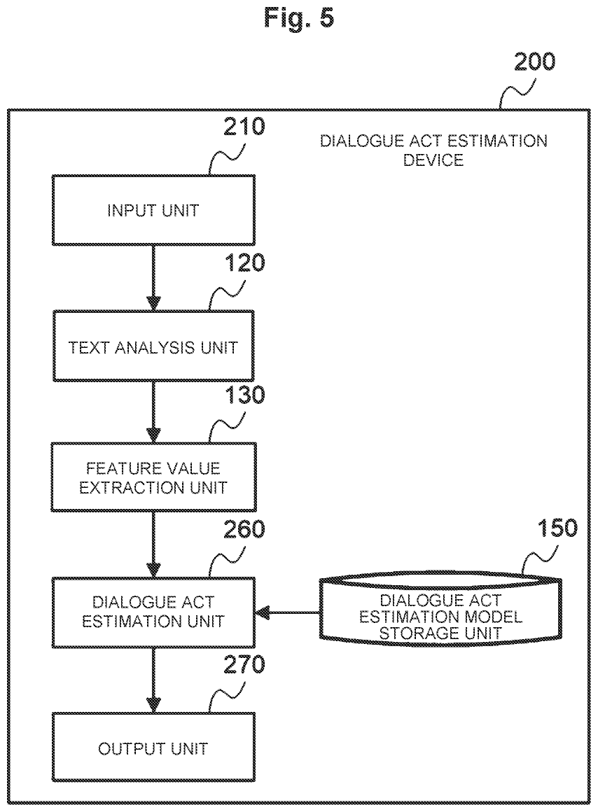

Now referring to FIGS. 1 and 5, configuration of a dialogue act estimation device 200 according to an embodiment of the present invention is described. Components similar to ones of the dialogue act estimation model learning device 100 according to the above embodiment of the present invention are given the same reference numerals and detailed description is omitted.

As shown in FIG. 1, the dialogue act estimation device 200 according to an embodiment of the present invention is composed of a computer including a CPU 11, a memory 12 such as RAM, a communication interface (IF) unit 13, an input unit 14 such as a keyboard, a display unit 15 such as a display, and a storage unit 16 such as ROM storing a program 27 for executing a dialogue act estimation process routine discussed later. The CPU 11, the memory 12, the communication IF unit 13, the input unit 14, the display unit 15, and the storage unit 16 are connected via a bus 10. The communication IF unit 13 can be connected to an external terminal over a communication line such as a LAN cable.

As shown in FIG. 5, the dialogue act estimation device 200 according to an embodiment of the present invention includes an input unit 210, a text analysis unit 120, a feature value extraction unit 130, a dialogue act estimation model storage unit 150, a dialogue act estimation unit 260, and an output unit 270.

The dialogue act estimation model storage unit 150 has stored therein a dialogue act estimation model and parameters of the dialogue act estimation model previously learned by the dialogue act estimation model learning device 100.

The input unit 210 receives input of a first utterance sentence and a second utterance sentence, which is an utterance sentence preceding the first utterance sentence, including at least the utterance sentence immediately preceding the first utterance sentence. Then, the input unit 210 passes the received first utterance sentence and the second utterance sentence to the text analysis unit 120.

The dialogue act estimation unit 260 estimates the dialogue act type of the first utterance sentence using aggregate feature value and the previously learned dialogue act estimation model for estimating a dialogue act type indicating the kind of dialogue act taking into account the utterance subject of the utterance sentence.

Specifically, the dialogue act estimation unit 260 first acquires the dialogue act estimation model and the parameters of the dialogue act estimation model from the dialogue act estimation model storage unit 150. Next, the dialogue act estimation unit 260 estimates the dialogue act type of the first utterance sentence based on the aggregate feature value extracted by the feature value extraction unit 130 and on the dialogue act estimation model acquired. Then, the dialogue act estimation unit 260 passes the estimated dialogue act type to the output unit 270.

The output unit 270 outputs the dialogue act type estimated by the dialogue act estimation unit 260.

<Action of the Dialogue Act Estimation Device According to an Embodiment of the Present Invention>

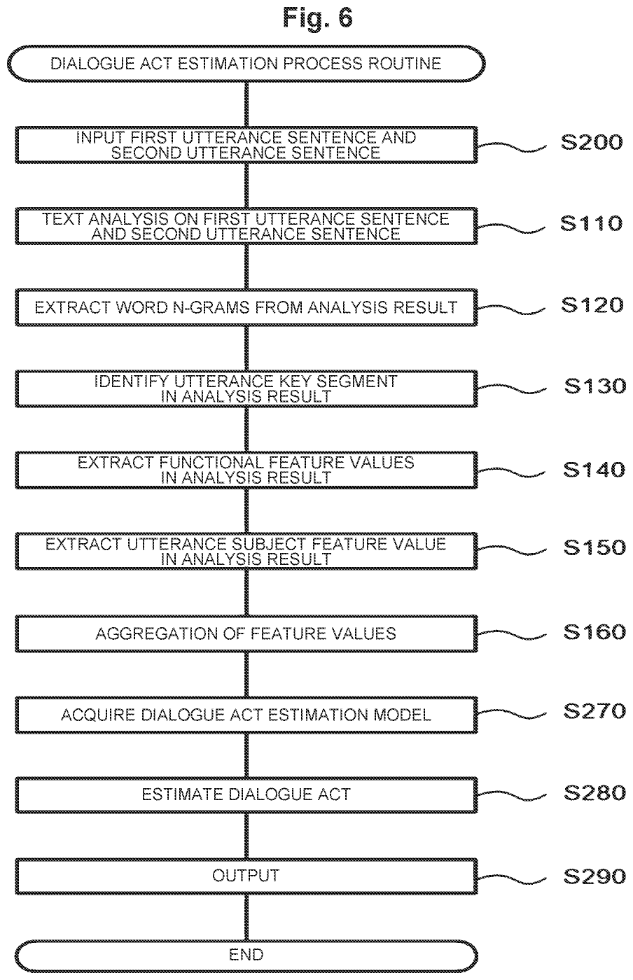

FIG. 6 is a flowchart illustrating a dialogue act estimation process routine according to an embodiment of the present invention. Processing steps similar to ones of the dialogue act estimation model learning process routine according to the above embodiment of the present invention are given the same reference numerals and detailed description is omitted.

In step S200, the input unit 210 receives input of a first utterance sentence and a second utterance sentence, which is an utterance sentence preceding the first utterance sentence, including at least the utterance sentence immediately preceding the first utterance sentence.

In step S270, the dialogue act estimation unit 260 acquires, from the dialogue act estimation model storage unit 150, a previously learned dialogue act estimation model for estimating a dialogue act type indicating the kind of dialogue act taking into account the utterance subject of the utterance sentence, and parameters of the dialogue act estimation model.

In step S280, the dialogue act estimation unit 260 estimates the dialogue act type of the first utterance sentence using aggregate feature value and the dialogue act estimation model acquired in step S270.

In step S290, the dialogue act type of the first utterance sentence estimated in step S280 is output.

As described above, the dialogue act estimation device according to the present embodiment can accurately estimate a dialogue act type taking the utterance subject into account by estimating the dialogue act type of the first utterance sentence using the aggregate feature value and the dialogue act estimation model. Here, the aggregate feature value is a feature value produced by extracting feature values including utterance subject feature values, which are feature values related to the utterance subjects of utterance sentences, for each of the first utterance sentence and the second utterance sentence, which is an utterance sentence preceding the first utterance sentence, including at least the utterance sentence immediately preceding the first utterance sentence, and by aggregating the extracted feature values for each of the first utterance sentence and the second utterance sentence. The dialogue act estimation model is a previously learned estimation model for estimating a dialogue act type indicating the kind of dialogue act taking into account the utterance subject of the utterance sentence. Then, based on the dialogue act type thus estimated, the dialogue system can appropriately select a response generation logic and thus the accuracy of dialogue of the overall dialogue system can be improved.

Moreover, since n-grams are also included in the aggregate feature value in the dialogue act estimation device according to the present embodiment, conventional schemes can be directly used with conventional dialogue act types for which the utterance subject is obvious, such as “Greeting” and “Feedback”.

Note that the present invention is not limited to the above-described embodiments and various modifications and applications are possible without departing from the scope of the invention.

Also, although embodiments where a program is pre-installed have been described herein, the program can also be provided by being stored in a computer-readable recording medium.

### REFERENCE SIGNS LIST

10 bus
11 CPU
12 memory
13 communication IF unit
14 input unit
15 display unit
16 storage unit
17 program
27 program
100 dialogue act estimation model learning device
110 input unit
120 text analysis unit
130 feature value extraction unit
131 word n-gram extraction section
132 utterance key segment identification section
133 functional feature value extraction section
134 utterance subject feature value extraction section
135 feature value aggregation section
140 model learning unit
150 dialogue act estimation model storage unit
200 dialogue act estimation device
210 input unit
260 dialogue act estimation unit
270 output unit

1. A dialogue act estimation device comprising:
an input receiver configured to receive input of a first utterance sentence and a second utterance sentence, the second utterance sentence being an utterance sentence preceding the first utterance sentence, including at least the utterance sentence immediately preceding the first utterance sentence;
a feature value extractor configured to extract feature values including an utterance subject feature value which is a feature value related to an utterance subject of an utterance sentence for each of the first utterance sentence and the second utterance sentence, and to aggregate the extracted feature values for each of the first utterance sentence and the second utterance sentence into an aggregate feature value; and
a dialogue act estimator configured to estimate a dialogue act type of the first utterance sentence using the aggregate feature value and a previously learned dialogue act estimation model for estimating the dialogue act type indicating a kind of dialogue act taking into account the utterance subject of an utterance sentence.

2. The dialogue act estimation device according to claim 1, wherein the feature value extractor comprises:
an utterance key segment identifier configured to identify an utterance key segment for each of the first utterance sentence and the second utterance sentence, the utterance key segment being a segment that best represents a content of an utterance sentence;
a functional feature value extractor configured to extract a functional feature value, the functional feature value being a functional feature value of the utterance sentence contained in the utterance key segment for each of the first utterance sentence and the second utterance sentence identified by the utterance key segment identifier;
an utterance subject feature value extractor configured to extract the utterance subject feature value of each of the first utterance sentence and the second utterance sentence based on the utterance key segment for each of the first utterance sentence and the second utterance sentence identified by the utterance key segment identifier; and
a feature value aggregator configured to generate the aggregate feature value by aggregating the functional feature value for each of the first utterance sentence and the second utterance sentence extracted by the functional feature value extractor, and the utterance subject feature value for each of the first utterance sentence and the second utterance sentence extracted by the utterance subject feature value extractor.

3. A dialogue act estimation model learning device comprising:
an input receiver configured to receive input of learning data including a first utterance sentence, a second utterance sentence, the second utterance sentence being an utterance sentence preceding the first utterance sentence, including at least the utterance sentence immediately preceding the first utterance sentence, and a dialogue act type indicating a kind of dialogue act taking into account an utterance subject of the first utterance sentence;
a feature value extractor configured to extract feature values including an utterance subject feature value which is a feature value related to an utterance subject of an utterance sentence for each of the first utterance sentence and the second utterance sentence, and to aggregate the extracted feature values for each of the first utterance sentence and the second utterance sentence into an aggregate feature value; and
a model learner configured to learn parameters of a dialogue act estimation model for estimating the dialogue act type indicating the kind of dialogue act taking into account the utterance subject of an utterance sentence, the learning performed such that the dialogue act type of the first utterance sentence which is estimated based on the aggregate feature value for the first utterance sentence and the second utterance sentence extracted by the feature value extractor and on the dialogue act estimation model agrees with the dialogue act type of the first utterance sentence included in the learning data.

4. A dialogue act estimation method, comprising:
receiving, by an input receiver, a first utterance sentence and a second utterance sentence, the second utterance sentence being an utterance sentence preceding the first utterance sentence, including at least the utterance sentence immediately preceding the first utterance sentence;
extracting, by a feature value extractor, feature values including an utterance subject feature value which is a feature value related to an utterance subject of an utterance sentence for each of the first utterance sentence and the second utterance sentence, and aggregates the extracted feature values for each of the first utterance sentence and the second utterance sentence into an aggregate feature value; and
estimating by a dialogue act estimator, a dialogue act type of the first utterance sentence using the aggregate feature value and a previously learned dialogue act estimation model for estimating the dialogue act type indicating a kind of dialogue act taking into account the utterance subject of an utterance sentence.

5. (canceled)

6. The dialogue act estimation method according to claim 4, further comprising:
identifying, by an utterance key segment identifier associated with the feature value extractor, an utterance key segment for each of the first utterance sentence and the second utterance sentence, the utterance key segment being a segment that best represents a content of an utterance sentence;
extracting, by a functional feature value extractor associated with the feature value extractor, a functional feature value, the functional feature value being a functional feature value of the utterance sentence contained in the utterance key segment for each of the first utterance sentence and the second utterance sentence identified by the utterance key segment identifier;
extracting, by an utterance subject feature value extractor associated with the feature value extractor, the utterance subject feature value of each of the first utterance sentence and the second utterance sentence based on the utterance key segment for each of the first utterance sentence and the second utterance sentence identified by the utterance key segment identifier; and
generating, by a feature value aggregator associated with the feature value extractor, the aggregate feature value by aggregating the functional feature value for each of the first utterance sentence and the second utterance sentence extracted by the functional feature value extractor, and the utterance subject feature value for each of the first utterance sentence and the second utterance sentence extracted by the utterance subject feature value extractor.
